(19) United States
(12) Patent Application Publication
(10) Pub. No.: US 2024/0247693 A1
(43) Pub. Date: Jul. 25, 2024

(54) CLUTCH SYSTEM FOR SELECTIVE ENGAGEMENT OF A VEHICLE DRIVE SYSTEM

(71) Applicant: GM GLOBAL TECHNOLOGY OPERATIONS LLC, Detroit, MI (US)

(72) Inventors: Farzad Samie, Franklin, MI (US); Dongxu Li, Troy, MI (US); Lei Hao, Troy, MI (US); Chunhao J. Lee, Troy, MI (US)

(21) Appl. No.: 18/157,200

(22) Filed: Jan. 20, 2023

(51) Int. Cl. B60K 6/383; B60K 6/387; F16D 41/12

(52) U.S. Cl. CPC B60K 6/383; B60K 6/387; F16D 41/125

(57) ABSTRACT

A system for selectively engaging and disengaging a drive shaft from an electric vehicle drive system includes a clutch device connected to the vehicle drive system, the vehicle drive system including an electric motor connected to a transmission system connecting the drive system to the drive shaft. The transmission system includes a first transfer gear connected to a second transfer gear by a transfer shaft, the second transfer gear is connected to the drive shaft, and the clutch device is disposed at the transfer shaft. The system also includes an actuator configured to control the clutch device to selectively engage the electric motor with the drive shaft, and to selectively disengage the electric motor from the drive shaft.

### INTRODUCTION

The subject disclosure relates to vehicles, and more specifically, to systems, devices and methods for selective engagement and disengagement of electric motors.

Vehicles, including gasoline and diesel power vehicles, as well as electric and hybrid electric vehicles, feature battery storage for purposes such as powering electric motors, electronics and other vehicle subsystems. Electric vehicles may feature single drive systems, or multi-drive systems that include two or more electric motors for applying torque. For example, some vehicles include a drive system for controlling torque applied to rear wheels, and another drive system for controlling torque to front wheels. In some instances, it may be desirable to disconnect an electric motor from a wheel or set of wheels for purposes such as charging and driving efficiency.

### SUMMARY

In one exemplary embodiment, a system for selectively engaging and disengaging a drive shaft from a vehicle drive system includes a clutch device connected to the vehicle drive system, the vehicle drive system including an electric motor connected to a transmission system connecting the vehicle drive system to the drive shaft. The transmission system includes a first transfer gear connected to a second transfer gear by a transfer shaft, the second transfer gear is connected to the drive shaft, and the clutch device is disposed at the transfer shaft. The system also includes an actuator configured to control the clutch device to selectively engage the electric motor with the drive shaft, and to selectively disengage the electric motor from the drive shaft.

In addition to one or more of the features described herein, the clutch device includes at least one of a dog clutch and a selectable one way clutch (SOWC).

In addition to one or more of the features described herein, the actuator is configured to move a slide member of the clutch device to engage the electric motor with the drive shaft or to disengage the electric motor from the drive shaft.

In addition to one or more of the features described herein, the actuator is disposed at the transfer shaft.

In addition to one or more of the features described herein, the system further includes a processing device configured to operate the actuator to control the clutch device.

In addition to one or more of the features described herein, the processing device is configured to operate the actuator to cause the clutch device to disengage the electric motor in response to at least one of a request to enter a charging mode, activation of a charging system, and a vehicle being in a selected operating mode.

In addition to one or more of the features described herein, the vehicle drive system includes a first drive system connected to a first drive shaft and a second drive system connected to a second drive shaft, and the processing device is configured to control the actuator to cause the clutch device to disengage the first drive system from the first drive shaft when the second drive system is engaged with the second drive shaft.

In addition to one or more of the features described herein, the clutch device includes a first clutch device disposed at a first transfer shaft of the first drive system, and a second clutch device disposed at a second transfer shaft of the second drive system.

In another exemplary embodiment, a method of selectively engaging and disengaging a drive shaft from a vehicle drive system includes controlling, by a processing device, a clutch device connected to the vehicle drive system, the vehicle drive system including an electric motor connected to a transmission system connecting the vehicle drive system to a drive shaft. The transmission system includes a first transfer gear connected to a second transfer gear by a transfer shaft, the second transfer gear is connected to the drive shaft, and the clutch device is disposed at the transfer shaft. Controlling the clutch device includes at least one of operating an actuator to control the clutch device to selectively engage the electric motor with the drive shaft, and operating the actuator to control the clutch device to selectively disengage the electric motor from the drive shaft.

In addition to one or more of the features described herein, the clutch device includes at least one of a dog clutch and a selectable one way clutch (SOWC).

In addition to one or more of the features described herein, the actuator is configured to move a slide member of the clutch device to engage the electric motor with the drive shaft or to disengage the electric motor from the drive shaft.

In addition to one or more of the features described herein, the actuator is disposed at the transfer shaft.

In addition to one or more of the features described herein, operating the actuator to control the clutch device to selectively disengage the electric motor from the drive shaft is performed in response to at least one of a request to enter a charging mode, activation of a charging system, and a vehicle being in a selected operating mode.

In addition to one or more of the features described herein, the vehicle drive system includes a first drive system connected to a first drive shaft and a second drive system connected to a second drive shaft, and controlling the clutch device includes operating the actuator to cause the clutch device to disengage the first drive system from the first drive shaft when the second drive system is engaged with the second drive shaft.

In addition to one or more of the features described herein, the clutch device includes a first clutch device disposed at a first transfer shaft of the first drive system, and a second clutch device disposed at a second transfer shaft of the second drive system.

In yet another exemplary embodiment, a vehicle system includes a memory having computer readable instructions, and a processing device for executing the computer readable instructions, the computer readable instructions controlling the processing device to perform a method. The method includes controlling a clutch device connected to a vehicle drive system, the vehicle drive system including an electric motor connected to a transmission system connecting the vehicle drive system to a drive shaft. The transmission system includes a first transfer gear connected to a second transfer gear by a transfer shaft, the second transfer gear is connected to the drive shaft, and the clutch device is disposed at the transfer shaft. Controlling the clutch device includes at least one of operating an actuator to control the clutch device to selectively engage the electric motor with the drive shaft, and operating the actuator to control the clutch device to selectively disengage the electric motor from the drive shaft.

In addition to one or more of the features described herein, the clutch device includes at least one of a dog clutch and a selectable one way clutch (SOWC).

In addition to one or more of the features described herein, operating the actuator to control the clutch device to selectively disengage the electric motor from the drive shaft is performed in response to at least one of a request to enter a charging mode, activation of a charging system, and a vehicle being in a selected operating mode.

In addition to one or more of the features described herein, the vehicle drive system includes a first drive system connected to a first drive shaft and a second drive system connected to a second drive shaft, and controlling the clutch device includes operating the actuator to cause the clutch device to disengage the first drive system from the first drive shaft when the second drive system is engaged with the second drive shaft.

In addition to one or more of the features described herein, the clutch device includes a first clutch device disposed at a first transfer shaft of the first drive system, and a second clutch device disposed at a second transfer shaft of the second drive system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a battery system and a multi-drive system, one or more drive systems of the multi-drive system including a compact clutch system, in accordance with an exemplary embodiment;

FIG. 2 depicts an electric motor and a transmission system of a vehicle, the transmission system including a clutch device for selectively engaging the electric motor with a drive shaft and selectively disengaging the electric motor from the drive shaft;

FIG. 3 depicts an example of a clutch device;

FIG. 4 depicts a portion of the clutch device of FIG. 3;

FIG. 5 is a flow diagram depicting aspects of a method of selectively engaging and disengaging a wheel and/or drive shaft from an electric vehicle drive system, in accordance with an exemplary embodiment; and

FIG. 6 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with exemplary embodiments, methods, devices and systems are provided for selectively engaging an electric motor drive system with a drive shaft and/or one or more vehicle wheels. Selective engagement and disengagement may be performed during vehicle charging, based on selected driving or operating conditions, and/or under other conditions. An embodiment of a selective engagement system includes a clutch device, such as a selectable one way clutch (SOWC) or a dog clutch, disposed at a transfer shaft of a vehicle transmission system. The clutch device is controllable by a processing device (e.g., a motor controller) to operate an actuator to transition the clutch device between at least one engaged position in which torque generated by an electric motor is transferred to a vehicle wheel or wheels, and a disengaged position in which torque is not transferred.

Embodiments described herein present numerous advantages and technical effects. The embodiments provide for a compact motor disconnect that can be installed in a drive system or transmission system without requiring significant redesign, and provides a quick and efficient mechanism to easily disengage an electric motor for purposes such as charging and selecting various vehicle operating modes. For example, in multi-drive vehicles, the embodiments provide for a way to easily disconnect a drive system to eliminate motor spin losses and improve driving range.

The embodiments are not limited to use with any specific vehicle and may be applicable to various contexts. For example, embodiments may be used with automobiles, trucks, aircraft, construction equipment, farm equipment, automated factory equipment and/or any other device or system that includes multiple drives and/or multiple conversion devices. In addition, although embodiments are described in conjunction with a vehicle having two drive systems, embodiments are applicable to vehicles having a single electric drive system or having any number of drive systems.

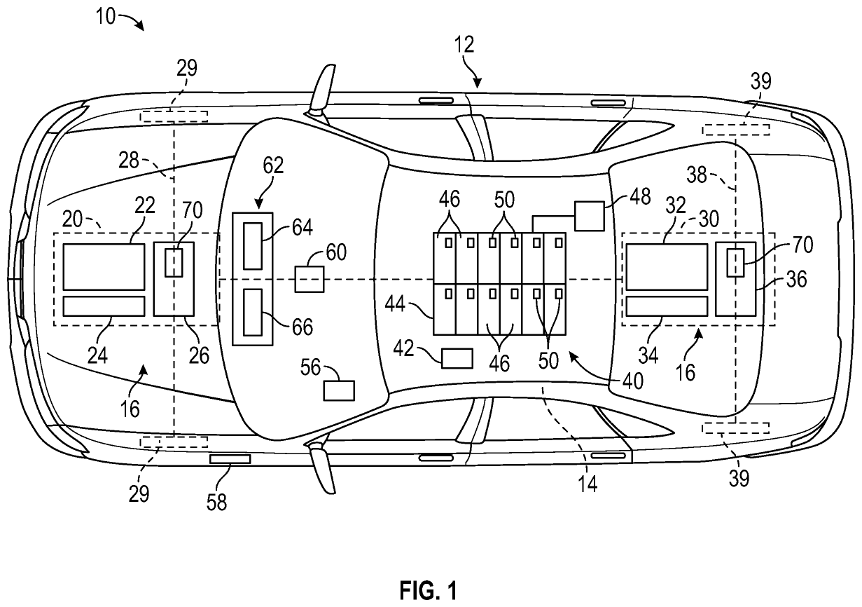

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and if the vehicle is a hybrid electric vehicle, a fuel injection subsystem, an exhaust subsystem and others.

The vehicle 10 may be an electrically powered vehicle (EV), a hybrid vehicle or any other vehicle that features multiple electric motors or drive systems. In an embodiment, the vehicle 10 is an electric vehicle that includes multiple motors and/or drive systems. For example, the propulsion system 16 is a multi-drive system that includes a first drive system 20 and a second drive system 30. The first drive system 20 includes a first electric motor 22 and a first inverter 24, as well as other components such as a cooling system. The first drive system 20 is connected to a transmission system 26 that includes a gearbox (not shown) for transferring torque from the first motor 22 to a drive shaft 28. The drive shaft is connected to front wheels 29.

The second drive system 30 includes a second electric motor 32 and a second inverter 34, and other components such as a cooling system. The second drive system 30 is connected to a transmission system 36 that includes a gearbox (not shown) for transferring torque from the second motor 32 to rear wheels 39 via a drive shaft 38.

The inverters 24 and 34 (e.g., traction power inverter units or TPIMs) each convert direct current (DC) power from a high voltage (HV) battery pack 44 to poly-phase (e.g., two-phase, three-phase, six-phase, etc.) alternating current (AC) power to drive the motors 22 and 32.

One or more drive systems or transmission systems include a clutch system having a clutch device and an actuator operable to control the clutch device to engage a drive system or motor from a vehicle wheel or wheels, and to disengage the drive system or motor from the vehicle wheel or wheels. The drive system or motor may be selectively engaged and disengaged based on a user request and/or a request from a vehicle system. In some embodiments, the clutch system can detect vehicle conditions and initiate engagement or disengagement automatically based on the detected conditions (i.e., detecting that a power source has been connected to the charge port 58 or otherwise detecting that the vehicle 10 is in a charging mode).

For example, the first transmission system 26 includes a clutch device 70, which may be disposed in the gearbox of either the first transmission system 26, the second transmission system 36, or both. Each clutch device 70 includes an actuator (e.g., a solenoid or hydraulic actuator) operable by a processing device to control the clutch device 70.

As shown in FIG. 1, the drive systems 20 and 30 are configured such that the first electric motor 22 drives the front wheels 29 and the second electric motor 32 drives the rear wheels 39. However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters. For a vehicle having multiple drive systems, a clutch device as described herein may be provided for each drive system, or provided with fewer than all of the drive systems.

The drive system 20 and the drive system 30 are electrically connected to a battery system 40, and may also be electrically connected to other components, such as vehicle electronics (e.g., via an auxiliary power module or APM 42). The battery system 40 may be configured as a rechargeable energy storage system (RESS).

In an embodiment, the battery system 40 includes a battery assembly such as the battery pack 44. The battery pack 44 includes a plurality of battery modules 46, where each battery module 46 includes a number of individual cells (not shown). The battery system 40 may also include a monitoring unit 48 configured to receive measurements from sensors 50. Each sensor 50 may be an assembly or system having one or more sensors for measuring various battery and environmental parameters, such as temperature, current and voltages.

The vehicle 10 may include a single motor or dual motor drive-based charging system that can be used to charge the battery pack 44 and/or used for supplying power from the battery pack 44 to charge another energy storage system (e.g., V2V charging). The charging system includes an onboard charging module (OBCM) 56 that is electrically connected to a charge port 58 for charging from an energy storage system such as a utility AC power supply. The charge port 58 may be configured to accept DC power for fast charging of the battery pack 44 directly when connected via DC contactors. In an embodiment, the charging system includes a universal charger that is configurable to provide for both DC and AC charging by selective operation of switches in the inverters 24 and 34.

Any of various processing devices or controllers can be used to control the clutch system(s) and clutch device(s) 70. A controller includes any suitable processing device or unit, and may be an existing controller such as the OCBM 56, and/or a controller in a drive system (e.g., a motor controller or processing device in a TPIM). For example, a controller 60 may be included for controlling the clutch device 70 of the drive system 20 and/or the drive system 30.

The vehicle 10 also includes a computer system 62 that includes one or more processing devices 64 and a user interface 66. The computer system 62 may communicate with the controller 60, for example, to provide commands thereto in response to a user input. The various processing devices, modules and units may communicate with one another via a communication device or system, such as a controller area network (CAN) or transmission control protocol (TCP) bus.

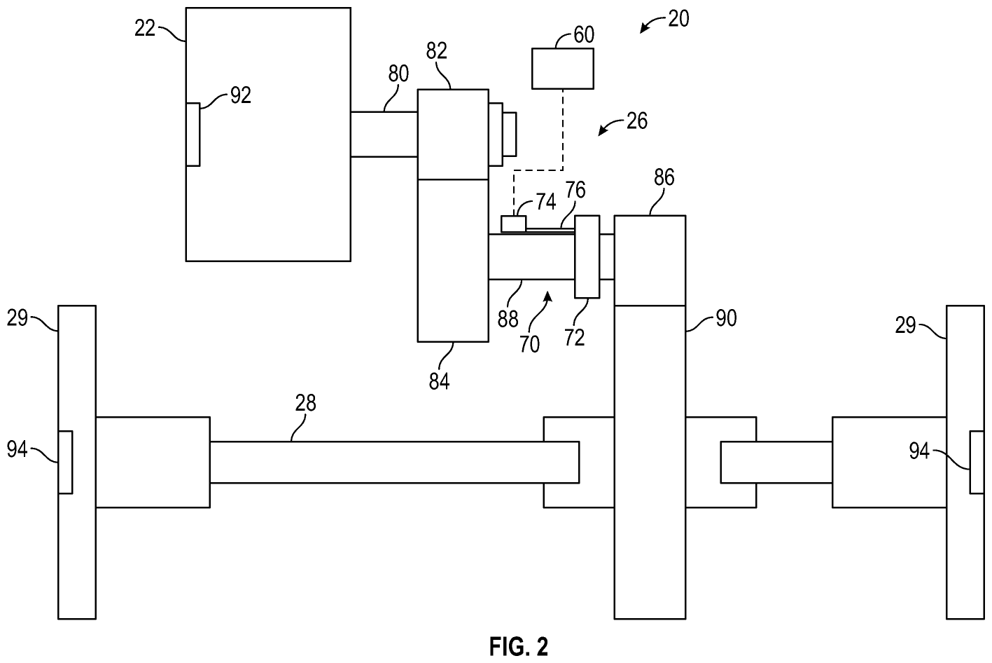

FIG. 2 depicts the drive system 20 and the transmission system 26, and also depicts an embodiment of the clutch system and the clutch device 70. In this embodiment, the clutch device 70 includes a clutch 72 and an actuator 74. The actuator 74 is operable to move an actuator member 76 relative to the clutch 72 to actuate the clutch 72 between various clutch positions. It is noted that the clutch device 70 can be similarly installed in the transmission system 36.

The motor 22 is connected to a motor shaft 80 and a motor shaft gear 82. The motor shaft gear 82 engages with a first transfer gear 84 that is connected to a second transfer gear 86 by a transfer shaft 88. The second transfer gear 86 engages an output gear 90 of the drive shaft 28.

In this embodiment, the clutch 72 is disposed at the transfer shaft 88, and divides the transfer shaft 88 into two shaft portions. When the clutch 72 is in an engaged position, torque from the motor 22 is transferred through the transfer shaft 88 (i.e., torque applied to the first shaft portion is transferred to the second shaft portion) to the second transfer gear 86 to drive the wheels 29. When the clutch 72 is in a disengaged position, the second transfer gear 86 is isolated from torque generated by the motor 22.

The actuator 74 may be a hydraulic actuator, a solenoid, a piezoelectric actuator or any other suitable device that is operable to translate the actuator member 76 in an axial direction along the transfer shaft 88 (or other suitable direction). Movement of the actuator member 76 causes the clutch 72 to transition between engaged and disengaged positions, and may also cause the clutch to transition between different engaged positions (e.g., a forward position in which torque from forward rotation is transferred, or a reverse position in which torque from reverse rotation is transferred).

The drive system 20 and/or the transmission system 26 may include various sensors, which can be used to facilitate operation of the clutch device 70. For example, sensors can be used by the controller 60 to determine if conditions exist such that the motor 22 should be disengaged. Such sensors include, but are not limited to, a resolver 92 for determining motor position and/or motor speed, and wheel speed sensors 94 for determining vehicle speed. Information from these sensors can be used to detect, for example, conditions where it is desirable to disengage the motor 22 (e.g., to put the vehicle 10 in a charging mode or in an operating mode in which only the drive system 30 provides torque). The sensors may also be used to determine conditions where it is desirable to engage the motor 22 (e.g., to transition the vehicle into a high performance driving mode or to provide extra torque).

Although not shown, the transmission system 26 may include other clutches at various locations. For example, one or more clutches may be located in the motor 22 or motor housing, and/or connected to one or more gears. In such instances, the clutch device 70 is provided in addition to other existing clutches.

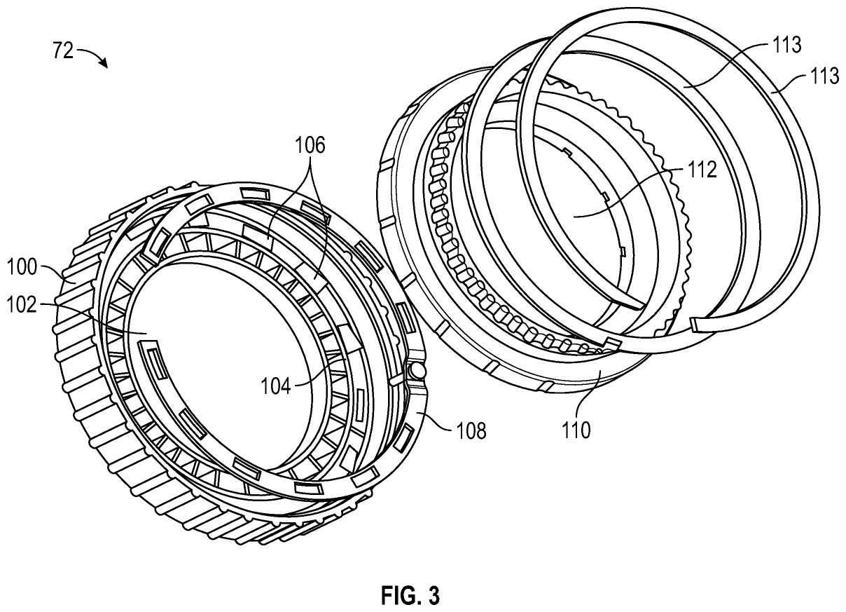

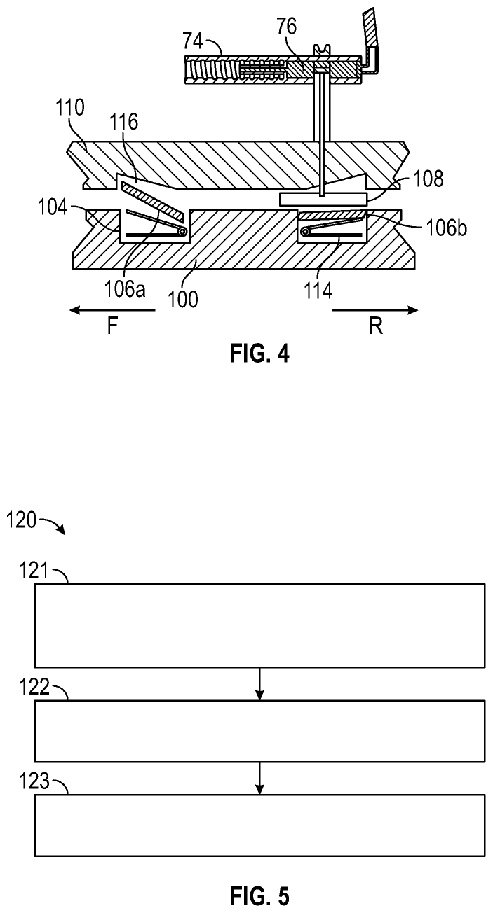

FIGS. 3 and 4 depict an embodiment of a clutch that can be used as part of the clutch device 70. In this embodiment, the clutch 72 is a selectable one way clutch (SOWC) 72. The SOWC 72 may be a dog clutch in which clutch plates engage via teeth or dogs, or a friction-type clutch. It is noted that the clutch 72 is not limited to a SOWC, as the clutch 72 may be of any suitable type.

The SOWC 72 includes a first race or pocket plate 100 having an internal bore 102 that includes a plurality of recesses 104. Each recess 104 holds a strut 106. The struts 106 are actuated to transition the clutch 72 from an engaged position, which may include a forward position and a reverse position, and a disengaged position. For example, the SOWC 72 is operable for holding torque in either rotational direction (i.e., forward and reverse), as well as for freewheeling, in response to positioning or movement of a selector plate 108 by the actuator member 76.

The SOWC 72 also includes a second race or notch plate 110 having an internal bore 112, and retaining plates 113 for retaining the pocket plate 100 with respect to the notch plate 110. The selector plate 108 (also referred to as a slide plate) is movable by an actuating component, such as the actuator member 76, to change a position of each strut 106 and thereby put the SOWC 72 in a desired position.

FIG. 4 depicts a cross-sectional view of a portion of the SOWC 72. As shown, the struts 106 (denoted as struts 106a and 106b) are disposed in respective recesses 104. Each strut 106 is biased toward an upward position by a leaf spring or other biasing member 114. When in the upward position, a strut 106 fits into an engagement recess 116 in the notch plate 110.

The clutch is shown in FIG. 4 as being in a forward position in which rotation of the pocket plate 100 in a forward direction F causes the notch plate 110 to also rotate, and thereby torque from forward rotation is transferred to vehicle wheels. Rotation of the pocket plate 100 in a reverse direction R does not affect the notch plate 110 (i.e., the notch plate 110 can freewheel in the reverse direction). In the forward position, the strut 106a is in an upward position, and the strut 106b is held in a downward position by the selector plate 108.

The selector plate 108 is moveable by the actuator member 76 between the forward position, a reverse position, and the disengaged position (freewheeling position). In the reverse position, the strut 106a is in the downward position and the strut 106b is in the upward position, and torque is transferred only when the pocket plate 110 rotates in the reverse direction R. In the disengaged position, both struts are in the downward position.

In this embodiment, the actuator 74 is a solenoid actuator in which the actuator member 76 is a plunger moveable by applying an electric signal. The actuator 74 is not so limited and can be any type of actuator, such as a hydraulic actuator.

FIG. 5 illustrates embodiments of a method 120 of controlling a propulsion or drive system, and controlling engagement and disengagement of a wheel or wheels of a vehicle relative to a motor of a drive system. Aspects of the method 120 may be performed by a processor or processors disposed in a vehicle, such as the controller 60. Other processors or processing devices that may be used to perform the method 120 include processors in an inverter module, the monitoring unit 48, the OBCM 56, the APM 42 and others.

The method 120 is described in conjunction with the vehicle 10 of FIG. 1 and the drive and transmission systems of FIG. 2. However, the method 120 is not so limited and can be used with any suitable vehicle and drive system having a clutch.

The method 120 includes a number of steps or stages represented by blocks 121-123. The method 120 is not limited to the number or order of steps therein, as some steps represented by blocks 121-123 may be performed in a different order than that described below, or fewer than all of the steps may be performed.

At block 121, the controller 60 determines whether it is desired to control the clutch device 70 to disengage the motor 22 from the drive shaft 28. The controller 60 may make this determination in response to a request input by a user or driver, or a request from another vehicle system or other remote entity. In an embodiment, the controller 60 monitors the drive units 20 and 30 and/or the vehicle 10 to determine conditions for which disengagement is desired.

In an embodiment, the controller 60 detects that the vehicle is in a charging mode or receives a request to disengage the motor 22 for charging. For example, if the charging system (including a universal charger or other charging configuration) is turned on, the controller 60 detects that the vehicle 10 is in a charging mode.

In an embodiment, the controller 60 detects that the vehicle is in a condition (e.g., at a certain speed, not accelerating, etc.) such that the motor 22 can be disengaged for efficiency or battery preservation. For example, the controller 60 detects that the vehicle 10 is in a condition for which disengagement is desired when the vehicle 10 is in an operating mode where only one motor (e.g., the motor 32) is providing torque for propulsion; in such a condition, it is determined that a motor or motors (e.g., the motor 22) not being used for propulsion should be disengaged.

At block 122, if disengagement is desired (e.g., the vehicle 10 is in the charging mode or a selected operating mode), the controller 60 operates the actuator 74 to move the actuator member 76 and cause the clutch 72 to disengage the portions of the transfer shaft 88. For example, the actuator member 76 is translated to move the selector plate 108 of the SOWC 72 (FIGS. 3 and 4).

At block 123, the controller 60 re-engages the clutch 72 so that torque is again transferred from the motor 22 to the drive shaft 28 (in the reverse or forward direction). Re-engagement is achieved by translating the actuator member 76 to cause the clutch 72 to re-engage the motor 22 with the drive shaft 28.

The method 120 is not limited to disengaging the clutch 72. For example, the method 120 may be applicable to engage a previously disengaged clutch 72, or transition the clutch 72 from a forward position to a reverse position or vice versa. For example, the controller 60 can engage a previously dis-engaged clutch 72 when the vehicle 10 is put into a high performance mode or other mode for which additional torque is desired.

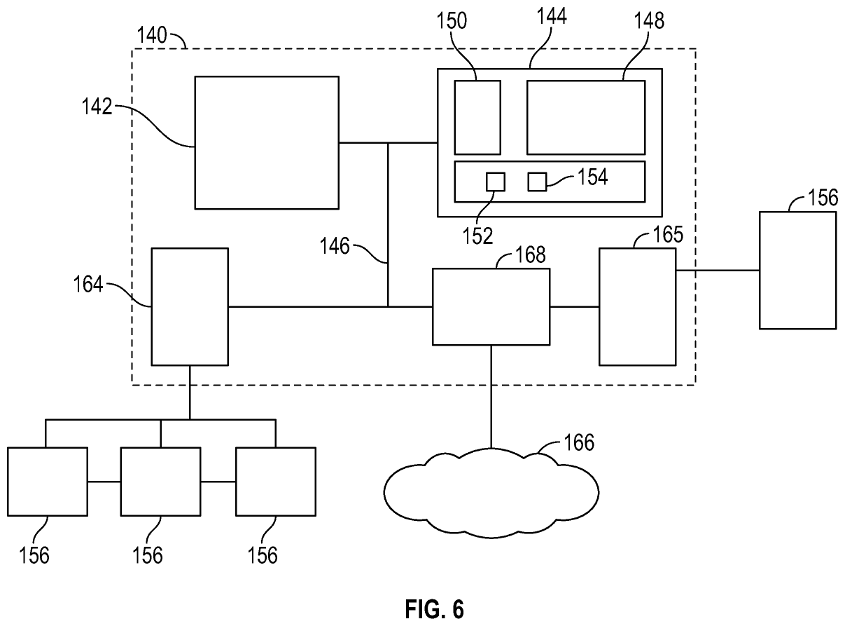

FIG. 6 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to receiving requests, and a module 154 may be included to perform functions related to control of a clutch system as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for selectively engaging and disengaging a drive shaft from a vehicle drive system, comprising:
a clutch device connected to the vehicle drive system, the vehicle drive system including an electric motor connected to a transmission system connecting the vehicle drive system to the drive shaft, the transmission system including a first transfer gear connected to a second transfer gear by a transfer shaft, the second transfer gear connected to the drive shaft, wherein the clutch device is disposed at the transfer shaft; and
an actuator configured to control the clutch device to selectively engage the electric motor with the drive shaft, and to selectively disengage the electric motor from the drive shaft.

2. The system of claim 1, wherein the clutch device includes at least one of a dog clutch and a selectable one way clutch (SOWC).

3. The system of claim 1, wherein the actuator is configured to move a slide member of the clutch device to engage the electric motor with the drive shaft or to disengage the electric motor from the drive shaft.

4. The system of claim 3, wherein the actuator is disposed at the transfer shaft.

5. The system of claim 1, further comprising a processing device configured to operate the actuator to control the clutch device.

6. The system of claim 5, wherein the processing device is configured to operate the actuator to cause the clutch device to disengage the electric motor in response to at least one of a request to enter a charging mode, activation of a charging system, and a vehicle being in a selected operating mode.

7. The system of claim 6, wherein the vehicle drive system includes a first drive system connected to a first drive shaft and a second drive system connected to a second drive shaft, and the processing device is configured to control the actuator to cause the clutch device to disengage the first drive system from the first drive shaft when the second drive system is engaged with the second drive shaft.

8. The system of claim 7, wherein the clutch device includes a first clutch device disposed at a first transfer shaft of the first drive system, and a second clutch device disposed at a second transfer shaft of the second drive system.

9. A method of selectively engaging and disengaging a drive shaft from a vehicle drive system, comprising:
controlling, by a processing device, a clutch device connected to the vehicle drive system, the vehicle drive system including an electric motor connected to a transmission system connecting the vehicle drive system to a drive shaft, the transmission system including a first transfer gear connected to a second transfer gear by a transfer shaft, the second transfer gear connected to the drive shaft, wherein the clutch device is disposed at the transfer shaft;
wherein controlling the clutch device includes at least one of operating an actuator to control the clutch device to selectively engage the electric motor with the drive shaft, and operating the actuator to control the clutch device to selectively disengage the electric motor from the drive shaft.

10. The method of claim 9, wherein the clutch device includes at least one of a dog clutch and a selectable one way clutch (SOWC).

11. The method of claim 9, wherein the actuator is configured to move a slide member of the clutch device to engage the electric motor with the drive shaft or to disengage the electric motor from the drive shaft

12. The method of claim 11, wherein the actuator is disposed at the transfer shaft.

13. The method of claim 9, wherein operating the actuator to control the clutch device to selectively disengage the electric motor from the drive shaft is performed in response to at least one of a request to enter a charging mode, activation of a charging system, and a vehicle being in a selected operating mode.

14. The method of claim 9, wherein the vehicle drive system includes a first drive system connected to a first drive shaft and a second drive system connected to a second drive shaft, and controlling the clutch device includes operating the actuator to cause the clutch device to disengage the first drive system from the first drive shaft when the second drive system is engaged with the second drive shaft.

15. The method of claim 14, wherein the clutch device includes a first clutch device disposed at a first transfer shaft of the first drive system, and a second clutch device disposed at a second transfer shaft of the second drive system.

16. A vehicle system comprising:
a memory having computer readable instructions; and
a processing device for executing the computer readable instructions, the computer readable instructions controlling the processing device to perform a method including:
controlling a clutch device connected to a vehicle drive system, the vehicle drive system including an electric motor connected to a transmission system connecting the vehicle drive system to a drive shaft, the transmission system including a first transfer gear connected to a second transfer gear by a transfer shaft, the second transfer gear connected to the drive shaft, wherein the clutch device is disposed at the transfer shaft;
wherein controlling the clutch device includes at least one of operating an actuator to control the clutch device to selectively engage the electric motor with the drive shaft, and operating the actuator to control the clutch device to selectively disengage the electric motor from the drive shaft.

17. The vehicle system of claim 16, wherein the clutch device includes at least one of a dog clutch and a selectable one way clutch (SOWC).

18. The vehicle system of claim 16, wherein operating the actuator to control the clutch device to selectively disengage the electric motor from the drive shaft is performed in response to at least one of a request to enter a charging mode, activation of a charging system, and a vehicle being in a selected operating mode.

19. The vehicle system of claim 16, wherein the vehicle drive system includes a first drive system connected to a first drive shaft and a second drive system connected to a second drive shaft, and controlling the clutch device includes operating the actuator to cause the clutch device to disengage the first drive system from the first drive shaft when the second drive system is engaged with the second drive shaft.

20. The vehicle system of claim 19, wherein the clutch device includes a first clutch device disposed at a first transfer shaft of the first drive system, and a second clutch device disposed at a second transfer shaft of the second drive system.
